(19) United States
(12) Patent Application Publication
(10) Pub. No.: US 2024/0412412 A1
(43) Pub. Date: Dec. 12, 2024

(54) SEGMENTATION BASED VISUAL SIMULTANEOUS LOCALIZATION AND MAPPING (SLAM)

(71) Applicant: NEC Corporation Of America, Herzlia (IL)

(72) Inventors: Tsvi LEV, Tel-Aviv (IL); Yaacov HOCH, Ramat-Gan (IL)

(73) Assignee: NEC Corporation Of America, Herzlia (IL)

(21) Appl. No.: 18/208,384

(22) Filed: Jun. 12, 2023

(51) Int. Cl. G06T 7/77; G06T 7/174; G06T 7/246

(52) U.S. Cl. CPC G06T 7/77; G06T 7/174; G06T 7/248

(57) ABSTRACT

Simultaneous location and mapping with improved accuracy by applying segmentation on images, and selecting patches having characteristics which are likely to enable reliable matching is disclosed. Geometric matching may be apply for generating sets of matching patches from different images. The camera distances and angulation may be calculated between estimated locations of patches in two or three dimensions, The location and mapping may be used for indoor and outdoor navigation, mapping, robotics, drones, localization, mapping, aerial image matching, panorama stitching and the like.

### FIELD AND BACKGROUND OF THE INVENTION

The present invention, in some embodiments thereof, relates to computer vision, and, more particularly, but not exclusively, use of segmentation to enhance localization and mapping.

Visual Simultaneous Localization and Mapping (visual SLAM/vSLAM) enables accurate mapping and navigation of indoor and outdoor environments for wide range of applications, such as robotics, drones, localization, mapping, aerial image matching, panorama stitching and the like. In robotics, for example while detecting and matching feature points in image frames obtained from an RGB-D sensor. The feature detectors used in vSLAM include Scale-Invariant Feature Transform (SIFT), Speeded Up Robust Features (SURF), Binary Robust Invariant Scalable Keypoints (BRISK), Oriented FAST and Rotated BRIEF (ORB), Features from Accelerated Segment Test (FAST), Good Features to Track (GFTT), GFTT with Harris detector enabled (GFTT_HARRIS) and STAR. Binary descriptors such as ORB, BRISK and Fast Retina Keypoint (FREAK) are typically used for finding point correspondences between images which are used for registration. Normalized cross correlation, and deep learning methods such as Learned Invariant Feature Transform (LIFT) descriptors are also used for vSLAM.

### SUMMARY OF THE INVENTION

It is an object of the present disclosure to provide a system, a method and one or more computer program products for providing estimate of relative camera angle and distance changes using image segmentation.

According to an aspect of some embodiments of the present invention there is provided a method for image matching, comprising:
receiving a plurality of images;
generating a first plurality of patches by applying segmentation on a first image from the plurality of images, and a second plurality of patches by applying segmentation on a second image from the plurality of images, each patch characterized by parameters;
selecting a group of patches from each plurality of patches, according to the parameters characterizing each patch;
generating a plurality of sets, each set comprising at least two patch from at least two different groups of patches by applying a geometric matching between the parameters characterizing each patch;
calculating a distance vector between a pivotal point of each of the patches in each of the plurality of sets; and
generating an estimate of relative camera angles and distances change by applying a statistical analysis on the distance vector pertaining to each of the plurality of sets.

According to an aspect of some embodiments of the present invention there is provided a system comprising a storage and at least one processing circuitry configured to:
receive a plurality of images;
generate a first plurality of patches by applying segmentation on a first image from the plurality of images, and a second plurality of patches by applying segmentation on a second image from the plurality of images, each patch characterized by parameters;
select a group of patches from each plurality of patches, according to the parameters characterizing each patch;
generate a plurality of sets, each set comprising at least two patch from at least two different groups of patches by applying a geometric matching between the parameters characterizing each patch;
calculate a distance vector between a pivotal point of each of the patches in each of the plurality of sets; and
generate an estimate of relative camera angles and distances change by applying a statistical analysis on the distance vector pertaining to each of the plurality of sets.

According to an aspect of some embodiments of the present invention there is provided one or more computer program products comprising instructions for image matching, wherein execution of the instructions by one or more processors of a computing system is to cause a computing system to:
receive a plurality of images;
generate a first plurality of patches by applying segmentation on a first image from the plurality of images, and a second plurality of patches by applying segmentation on a second image from the plurality of images, each patch characterized by parameters;
select a group of patches from each plurality of patches, according to the parameters characterizing each patch;
generate a plurality of sets, each set comprising at least two patch from at least two different groups of patches by applying a geometric matching between the parameters characterizing each patch;
calculate a distance vector between a pivotal point of each of the patches in each of the plurality of sets; and
generate an estimate of relative camera angles and distances change by applying a statistical analysis on the distance vector pertaining to each of the plurality of sets.

Optionally, the pivotal point is the centroid of an associated patch from the plurality of patches.

Optionally, the parameters comprise a clarity score of a boundary of each patch from the first plurality of patches.

Optionally, the parameters comprise a size measure of each patch from the first plurality of patches.

Optionally, the parameters comprise a convexity score of each patch from the first plurality of patches.

Optionally, the statistical analysis comprising cross correlation of pivotal points locations.

Optionally, the plurality of images comprising at least three images and the statistical analysis comprising estimating a movement path by at least one of the plurality of sets.

Optionally, further comprising generating at least one set based on a localized feature descriptor.

Optionally, further comprising computing a probability the second image and the first image depict a same scene in physical space according to the parameters and updating a map pertaining to relative overlap.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic of a block diagram of components of a system 100 for computing a segmentation-based localization 104 based on segmentation of images of an environment 108 captured by an image sensor 104, in accordance with some embodiments of the present invention;

FIG. 2 is a flowchart of a method for computing a segmentation-based localization, in accordance with some embodiments of the present invention;

FIG. 3A is a depicts a first image 302 and a second image 304 for which ego-motion of an image sensor and/or which may be used for updating a map of an environment, in accordance with some embodiments of the present invention;

FIG. 3B, is includes a segmented image 306 of image 302, and a segmented image 308 of image 304, in accordance with some embodiments of the present invention;

FIG. 3C includes pairs 312A-B, 314A-B, 316A-B, 318A-B of images with matching segmentations, in accordance with some embodiments of the present invention;

FIG. 4A includes two images 402 and 422 captured by a camera on a drone, in accordance with some embodiments of the present invention;

FIG. 4B, includes two image 404 and 424 with associated pluralities of patches generated by applying segmentation on the images 402 and 422 respectively, in accordance with some embodiments of the present invention; and

FIG. 4C, is a graph 406 depicting location tracking of the drone using matching segmentations of images, in accordance with some embodiments of the present invention.

### DESCRIPTION OF SPECIFIC EMBODIMENTS OF THE INVENTION

The present invention, in some embodiments thereof, relates to computer vision, and, more particularly, but not exclusively, use of segmentation to enhance localization and mapping

While some methods of vSLAM are effective in many situations some cases such as low-texture environments, highly dynamic environments, unexpected poses, or where many transparent, translucent, and/or reflective surfaces are present the performance and reliability may be inadequate.

At least some embodiments of the systems, methods, computing devices, and/or code instructions described herein (stored on a data storage device and executable by a processor(s)) address the technical problem of improving visual SLAM approaches. At least some embodiments of the systems, methods, computing devices, and/or code instructions described herein improve the technical field of visual SLAM, by improving accuracy of computing the pose of the image sensor and/or generated map. At least some embodiments of the systems, methods, computing devices, and/or code instructions described herein improve upon existing approaches for visual SLAM. Existing visual SLAM approaches are based on, for example, normalized cross correlation of the whole images, feature matching (e.g., SURF, BRISK), and deep learning. Existing visual SLAM approaches tend to fail and/or provide reduced accuracy of computing the pose of the image sensor and/or generated map, for example:
When the scene depicted in the images is viewed from different angles.
When many surfaces in the scene are transparent, translucent, and/or reflective.
Where reference image samples were not acquired, and/or the reference samples were not used for training a model.
When lighting is significantly different between images.
When the physical environment is significantly different between images.
When the environment depicted in the images has few distinct localized features (e.g., strong edges, points, marks).
When one or more of the images are blurry, for example, due to camera motion, improper focus, and the like.

At least some embodiments of the systems, methods, computing devices, and/or code instructions described herein improve accuracy by applying segmentation on images, and selecting patches having characteristics which are likely to enable reliable matching. Followingly some implementations may apply geometric matching for generating sets of matching patches from different images. Followingly some implementations may calculate distances between estimated locations of patches in two or three dimensions, and use the distances to estimate relative camera angles and distances.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

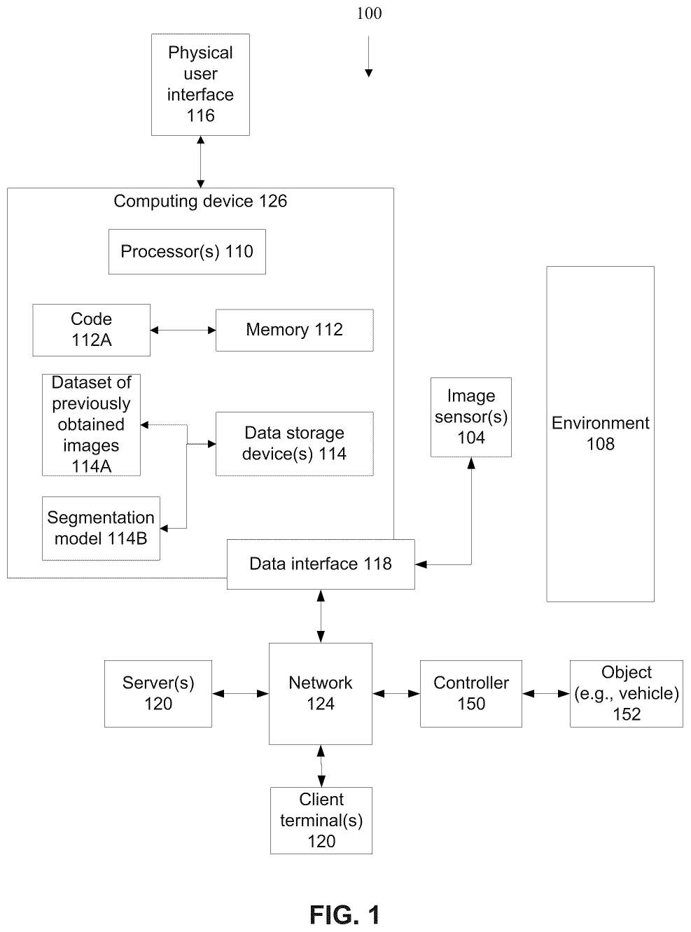

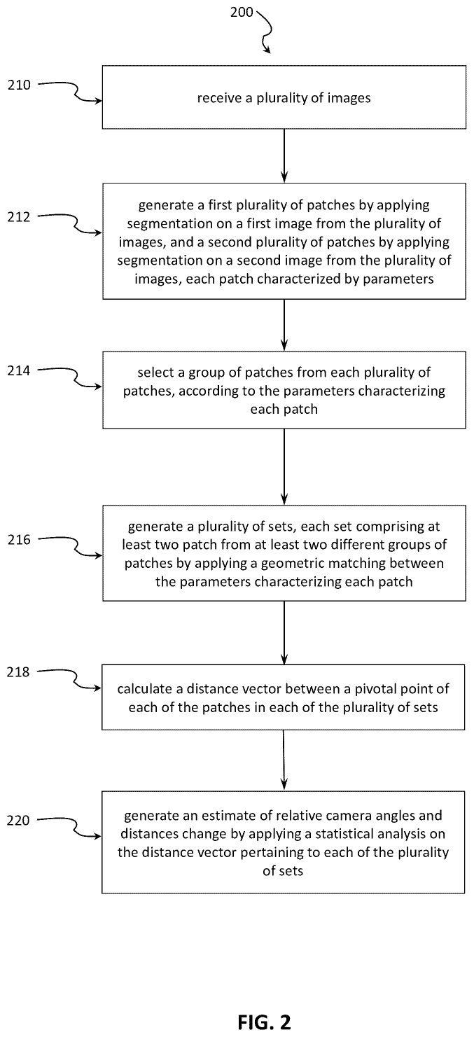

Reference is now made to FIG. 1, which is a schematic of a block diagram of components of a system 100 for computing a segmentation-based localization 104 based on segmentation of images of an environment 108 captured by an image sensor 104, in accordance with some embodiments of the present invention. Reference is also made to FIG. 2, which is a flowchart of a method for computing a segmentation-based localization, in accordance with some embodiments of the present invention. System 100 may implement the acts of the method described with reference to FIG. 2, by processor(s) 110 of a computing device 126 executing code instructions (e.g., code 112A) stored on a memory 112.

Image sensor(s) 104 may be used to for mapping or scanning a scene such as a room or a a forest, a mount or a comet. The system may also compute the ego-motion and/or location of an object 152, for example, a robot, a drone, a vehicle, a wheelchair, a device attached to an animal such as a sheep, a bird or a tiger, and/or the like.

Inage sensor(s) 104 may be installed on object 152.

Object 152 may be in communication with a controller 150 that receives the computed location of object 152. Controller 150 may, generate instructions for automated movement and/or navigation of object 152 according to the computed location in some applications, either to perform an action such as lifting, taking additional images for mapping, and/or the like.

Object 152 may move over a surface of environment 108.

Environment 108 may be, for example, a city, desert terrain, the surface of the moon, the surface of mars, a road, a room, a warehouse and the like.

Imaging sensors 104 are set for capturing one or more images of environment 108. Imaging sensor(s) 104 capture images at certain wavelengths, for example, one or more ranges within the visible light spectrum, ultraviolet (UV), infrared (IR), near infrared (NIR), and the like. Examples of imaging sensor(s) 104 include a camera and/or video camera, such as CCD, CMOS, and the like. Imaging sensor(s) 104 may be implemented as, for example, a short wave infrared (SWIR) sensor that captures SWIR image(s) of surface 108 at a SWIR wavelength, optionally including a solar blind range. Examples of SWIR sensor(s) 104 may comprise plasmon based CMOR, balometer array based FIR, and 3D passive imaging.

As used herein, the term “solar blind range” refers to the wavelength spectrum at which electromagnetic radiation (e.g., generated by sunlight and/or artificial light sources) is highly (e.g., mostly) absorbed in the atmosphere (e.g., by water vapor in air) and/or has low emission for example, the range of about 1350-1450 nm, optionally 1360-1380 nm. Additional details of the solar blind range and SWIR sensor(s) for capturing image at the solar blind range are described herein and/or with reference to U.S. patent application Ser. No. 17/689,109 filed on Mar. 8, 2022, by at least one common inventor of the instant application, the contents of which are incorporated herein by reference in their entirety.

Optionally, system 100 may include one or more illumination elements 106 that generate electromagnetic illumination at a selected electromagnetic frequency range that is captured by imaging sensor(s) 104, for example, SWIR illumination optionally at the solar blind range, one or more ranges within the visible light spectrum (e.g., white or one or more colors), ultraviolet (UV), infrared (IR), near infrared (NIR), and the like. Imaging methods such as Synthetic Aperture Radar (SAR) and the likes may also be used.

System 100 includes a computing device 126, for example one or more and/or combination of: a group of connected devices, a client terminal, a vehicle electronic control unit (ECU), a server, a computing cloud, a virtual server, a computing cloud, a virtual machine, a desktop computer, a thin client, a network node, a network server, and/or a mobile device (e.g., a Smartphone, a Tablet computer, a laptop computer, a wearable computer, glasses computer, and a watch computer).

System 100 and/or computing device 126 include one or more processor(s) 110, which may interface with imaging sensor(s) 104 for receiving image(s) of environment 108. Processor(s) 110 may interface with other components, described herein. Processor(s) 110 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 110 may include a single processor, or multiple processors (homogenous or heterogeneous) arranged for parallel processing, as clusters and/or as one or more multi core processing devices.

System 100 and/or computing device 126 include a memory 112, which stores code 112A for execution by processor(s) 110. Code 112A may include program instructions for implementing one or more features of the method described with reference to FIG. 2, as described herein. Memory 112 may be implemented as, for example, a random access memory (RAM), read-only memory (ROM), and/or a storage device, for example, non-volatile memory, magnetic media, semiconductor memory devices, hard drive, removable storage, and optical media (e.g., DVD, CD-ROM).

System 100 and/or computing device 126 include a data storage device(s) 114, which may store data, for example, a dataset of previously images 114A of environment 108, and/or a segmentation model 114B, as described herein. Data storage device(s) 114 may be implemented as, for example, a memory, a local hard-drive, virtual storage, a removable storage unit, an optical disk, a storage device, and/or as a remote server and/or computing cloud (e.g., accessed using a network connection).

System 100 and/or computing device 126 may include a physical user interface 116 that includes a mechanism for user interaction, for example, to enter data and/or to view data. Exemplary physical user interfaces 116 include, for example, one or more of, a touchscreen, a display, gesture activation devices, a keyboard, a mouse, and voice activated software using speakers and microphone.

System 100 and/or computing device 126 may include a data interface 118 for providing communication with controller 150 and/or other external devices (e.g., server(s) 120 and/or client terminal(s) 122) optionally over a network 124, for example, for receiving images of environment 108 and/or providing the ego-motion of image sensor 104 and/or mapping environment 108. Data interface 118 may be implemented as, for example, one or more of, a network interface, a vehicle data interface, a USB port, a network interface card, an antenna, a wireless interface to connect to a wireless network, a short range wireless connection, a physical interface for connecting to a cable for network connectivity, a virtual interface implemented in software, network communication software providing higher layers of network connectivity, and/or other implementations.

Computing device 126 may interface with other components using data interface 118, for example, with illumination element 106 (e.g., for controlling an illumination pattern) and/or with imaging sensor 104.

Network 124 may be implemented as, for example, a vehicle network, the internet, a broadcast network, a local area network, a virtual network, a wireless network, a cellular network, a local bus, a point to point link (e.g., wired), and/or combinations of the aforementioned. It is noted that a cable connecting processor(s) 110 and another device may be referred to herein as network 124.

Controller 150 may be in communication with vehicle (i.e., object) 152. Controller 150 may compute instructions for navigation of the vehicle based on the computed location.

Server(s) 120 and/or client terminal(s) 122 may be implemented as, for example, remote devices for monitoring locations of one or more objects, and/or for remote navigation of the objects according to the computed locations.

System 100 may be implemented as different architectures. For example, in a server-client architecture, computing device 126 is implemented as a server that receives images of environment 108 captured by imaging sensor 104 from a client terminal over network 124. Computing device 126 may compute the ego-motion of image sensor 104 and/or map of environment 108 as described herein, and provides the result(s), for example, to client terminal 122. In another local example, computing device 126 is implemented as a local computer that receives images of environment 108 captured by imaging sensor 104 and locally computes the ego-motion of image sensor 104 and/or map of environment 108 as described herein, and provides the result(s). For example, computing device 126 is located as software and/or hardware installed in a vehicle such as a forklift, a tractor or a drone, and/or robot for real-time navigation thereof.

Referring now back to FIG. 2, at 200, components of a process executed by the system described with reference to FIG. 1 may be setup on the object, or performed on images received from the object, a sever 120, or the like.

The object may be, for example, a vehicle, a robot, a vehicle, a drone, or a device attached to a living animal such as a horse or a sheep.

Components of the system may be installed as an add-on to provide dynamic real time localization of the object during motion. For example, imaging sensors may be installed on the object, and/or images captures by existing imaging sensors of the object are accessed. Code and/or processors for processing the images and/or computing the location may be installed in association with existing data storage device(s) and/or data storage device(s) storing the code and/or processor(s) may be installed in the object. The add-on component may be implemented as, for example, a vehicle electronic control unit (ECU) that is connected to the vehicle network, and/or an external camera and smartphone storing the code that is independent of the object and/or connected to the vehicle network. Some other implementations receive the images from storage over the network, and/or the like, additionally or alternatively.

The processor(s) 110 may execute the exemplary process 200 for a variety of purposes involving localization, mapping, panorama stitching, image matching and/or the like. Alternatively, the process 200 or parts thereof may be executing using a remote system, an auxiliary system, and/or the like.

The exemplary process 200 starts, as shown in 210, with receiving a plurality of images. The images may be received in various formats, raw or compressed, in RGB colors, CMY, or representing a palette based on different wavelengths such as infrared, X-ray or ultraviolet, a scan such as a SAR, ultrasound, RGBD, and/or the like. The images may be received from sensors such as 104, storage, network such as 124, and/or the like.

The exemplary process 200 continues, as shown in 212, with generating a first plurality of patches by applying segmentation on a first image from the plurality of images, and a second plurality of patches by applying segmentation on a second image from the plurality of images, each patch characterized by parameters.

A plurality of patches may be generated by applying various segmentation methods on an image, such as region-based segmentation, edge-based segmentation, deep learning, and/or the like to divide each image into distinct regions.

Some region-based segmentation methods include thresholding, where pixels are assigned to regions based on intensity thresholds. Clustering algorithms, such as k-means, for example imsegkmeans by or mean-shift, which group similar pixels into regions, and graph-based methods like the GrabCut algorithm, which iteratively refine regions based on color and spatial information, may also be used. Other clustering algorithms such as Density-Based Spatial Clustering of Applications with Noise (DBSCAN), methods such aggregative and/or divisive hierarchical clustering, and deep learning based clustering methods such as Deep Embedded Clustering (DEC) or Self-Organizing Maps (SOM) may also be applied.

In 3D representations that may also be treated similarly to images methods such as Voxel Clustering

In 3D representations that may also be treated similarly to images methods such as 3D Convolutional Neural Networks (3D CNN), region growing for polygons, or the like, and clustering algorithms such as DBSCAN or k-means may be used on point clouds.

Some segmentation methods may detect edges to delineate boundaries and extract multiple patches accordingly. Edge-based segmentation methods may rely on detecting and highlighting edges within an image to separate regions. Examples comprise the Canny edge detection algorithm, which identifies edges by analyzing gradients, and the Sobel operator, which calculates gradients along the x and y axes to locate edges based on intensity changes. Other edge-based methods include the Laplacian of Gaussian (LoG) operator, which highlights edges at different scales, and the gradient magnitude approach, which emphasizes areas with strong intensity variations.

Deep learning based segmentation may be applied using one or more existing model, as well as models that may be developed in the future. Some other deep learning-based segmentation methods may be based on the following models:
Fully Convolutional Network (FCN) is designed specifically for semantic segmentation tasks, which unlike classification networks, replaces fully connected layers with convolutional layers to allow for spatial information preservation.
U-Net: A popular architecture for image segmentation that utilizes a network, where the middle layers have smaller spatial dimension, using encoder and decoder pathway to capture context and high-resolution details.
Mask R-CNN: Combining the concepts of region-based convolutional neural networks (R-CNN) and instance segmentation, Mask R-CNN generates pixel-level masks for each object instance in an image.
DeepLab: which uses atrous convolutions and spatial pyramid pooling to capture multi-scale contextual information, and may improve localization of object boundaries by combining methods from DCNNs and probabilistic graphical models such as conditional random fields.
Pyramid Scene Parsing Network (PSPNet) leverages a pyramid-pooling module to capture multi-scale context information, and aggregate global context information by different-region based contexts.

In 3D representations that may also be treated similarly to images methods such as 3D Convolutional Neural Networks (3D CNN) for voxels, graph cut algorithms for polygons, PointNet for point clouds, and/or the like.

Some embodiments may apply segmentation using combinations of deep learning based methods and other methods.

A plurality of patches pertaining to each image, i.e. the first image, second image, and optionally additional images, may be applied by processing each image separately, however some implementation may propagate information from other images on prospective segmentations or in earlier stages of the processing, for example when the displacement between the images was measured using a gyro or a positioning system such as GPS. Such propagation may improve performance, for example robustness against noise. Parameters may be assigned to each patch from each of the plurality of patches, for example the first plurality of patches and the second plurality of patches.

The parameters charactering the patches may include location and size, and criteria such as a size measure, a convexity score of the patch, edges smoothness and convexity, patterns in edges, corners, texture features, color mean, color gradient, color histogram, straight versus curved edges, confidence level in edge location, a clarity score of a boundary, other shape attributes, object content, geometrical constraints and/or the like. Some implementation may comprise using one or more localized feature descriptor, and segment parameters may be combined with traditional or other localized feature selection and matching methods like SIFT, SURF and/or the like.

The exemplary process 200 continues, as shown in 214, with selecting a group of patches from each plurality of patches, according to the parameters characterizing each patch. It may be beneficial to discard patches having lower likelihood to be distinctive and easy to compare with patches from other images to optimize speed and confidence level.

The group may be of a fixed size, such as 10, 20, or 100, or a variable size, determined according to the number of patches meeting some criteria, for example pertaining to distinctiveness or ability to match. For example, in some implementations, segmented patches whose size range ranges for example 0.1%-2% of the image frame may be preferred, a shape having at least half of the perimeter as straight lines, shapes having distinctive patterns, other geometric solidity measures, and/or the like.

The exemplary process 200 continues, as shown in 216, with generating a plurality of sets, each set comprising at least two patch from at least two different groups of patches by applying a geometric matching between the parameters characterizing each patch.

Set may represent patches which are likely to pertain to the same object in the environment from which the images where taken. Finding the best match may be based on maximum 2D cross correlation between a patch from a group of patches pertaining to a first image and a patch from a group of patches pertaining to a second image, for example the next frame. A distance measure may be based on expected motion, and correspondingly the cross correlation threshold may be high such as 0.8 or 0.9. Some other applications may use parameters such as color, patterns, local descriptors, and/or the like.

In some implementations where the parameters comprise localized feature selection and matching using descriptors such as SIFT, one or more sets based on one or more localized feature descriptors may be generated.

The exemplary process 200 continues, as shown in 218, with calculating a distance vector between a pivotal point of each of the patches in each of the plurality of sets. The pivotal point may be the centroid of an associated patch from the plurality of patches, however other points such as the top left corner or the center of the longest boundary edge may be used.

The distance vector may be the delta X and Y between the matched pivotal points of the patches. Some implementations may also apply a depth estimation or a Z axis, for example in RGBD images or other 3D representations.

And subsequently, as shown in 220, the process 200 may continue by generating an estimate of relative camera angles and distances change by applying a statistical analysis on the distance vector pertaining to each of the plurality of sets.

The estimate may be generated using cross correlation of pivotal points locations. Alternatively, Iterative Closest Point (ICP), Traditional methods used with local feature-based methods such as Random Sample Consensus (RANSAC) or graph-based optimization may also be used.

In some implementations, the plurality of images may comprise at least three images and the statistical analysis may be by estimating a movement path by at least one of the plurality of sets. This may be useful for sequences of images.

Various embodiments and/or aspects of the present disclosure as delineated hereinabove and as claimed in the claims section below find experimental and/or calculated support in the following examples.

### EXAMPLES

Reference is now made to the following examples, which together with the above descriptions illustrate some embodiments of the present disclosure in at necessarily limiting fashion.

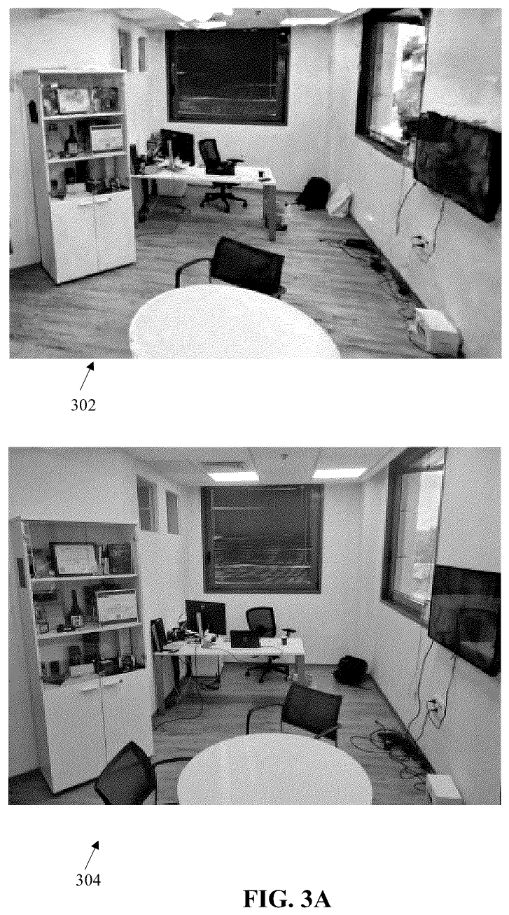

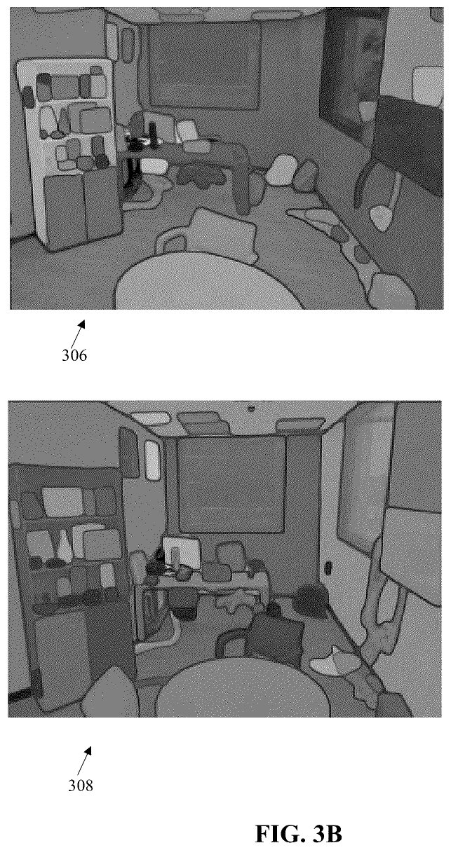

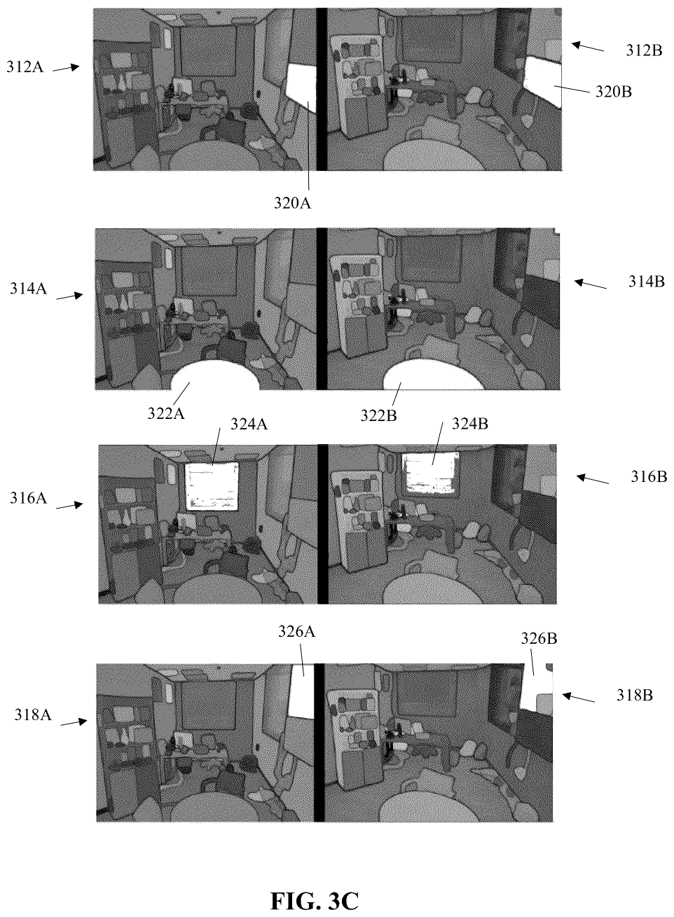

Reference is now made to FIG. 3A, which depicts a first image 302 and a second image 304 for which ego-motion of an image sensor and/or which may be used for updating a map of an environment, in accordance with some embodiments of the present invention.

Image 302 is a rendered 3D image created using a 3D machine learning model (Neural Radiance Field (NeRF)) fed a previously scanned set of images. Image 302 depicts an office room.

Image 304 is a frame from a live video of the same office room depicted in image 302. Image 304 is taken at a different date than the images used to create image 302, and therefore includes new objects that are not depicted in image 302, and/or includes objects which are depicted in image 302 and have been moved to a different location and/or different orientation. Images 302 and 304 overlap at least partially.

Reference is now made to FIG. 3B, which includes a segmented image 306 of image 302, and a segmented image 308 of image 304, in accordance with some embodiments of the present invention. Segmented images 306 and 308 each include segmentations, where each segmentation is depicted as a contiguous pixel region of pixels with a same pixel intensity and/or same color. The segmented images 306 and 308 were created by feeding images 302 and 304 into a trained machine learning model (e.g., Segment Anything Model (SAM)).

A segmented patch, which does not relate to a real object as decided by a human watching the original photograph may be referred to as a fake object would refer to. For example, a part of a shadow on a wall, or reflection on a glass might be given a unique segment in the segmentation result, but for the human eye, it would just be interpreted as part of the bigger contiguous wall. An important characteristic of fake objects, patches, segments or segmentations is that they tend to change or disappear under small camera movements and/or environment changes. Therefore, patches referred to as fake objects may not provide a reliable indication of camera motion. For example, a slight shadow might disappear from view and from segmentation if viewed from a different angle or at a different time.

Reference is now made to FIG. 3C, which includes pairs 312A-B, 314A-B, 316A-B, 318A-B of images with matching segmentations, in accordance with some embodiments of the present invention. The first image 312A, 314A, 316A, 318A of each pair is segmented image 306 with a marked segmentation 320A, 322A, 324A, 326B that substantially matches a marked segmentation 320B, 322B, 324B, 326B of the second image 312B, 314B, 316B, and 318B. The second image is segmented image 308. The matching segmentations may be found using a segmentation method, mapping of segments by parameters and matching to one or more most similar patches, matching patches iteratively based on a tentative transportation, and/or the like.

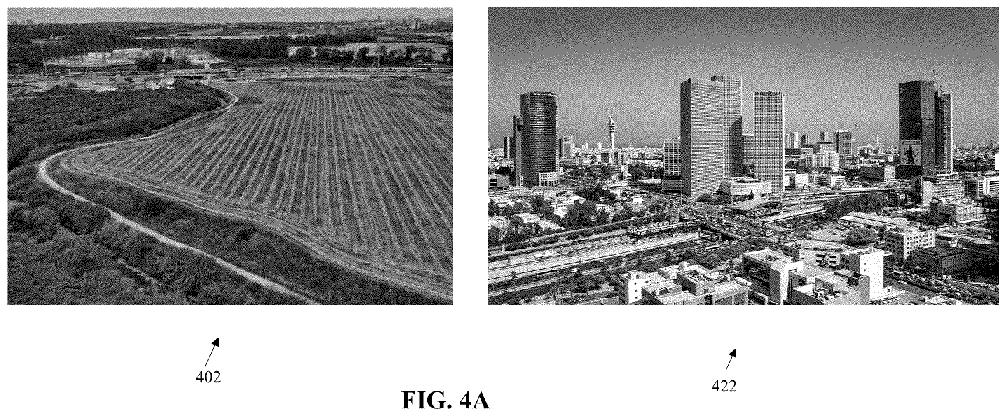

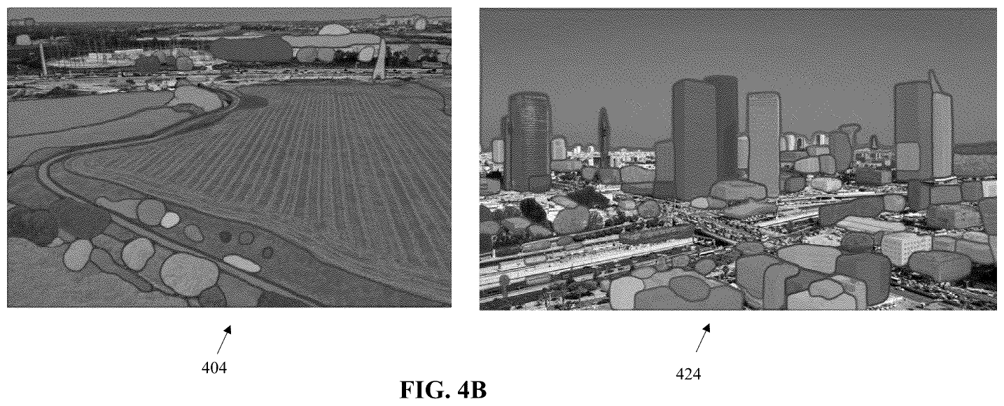

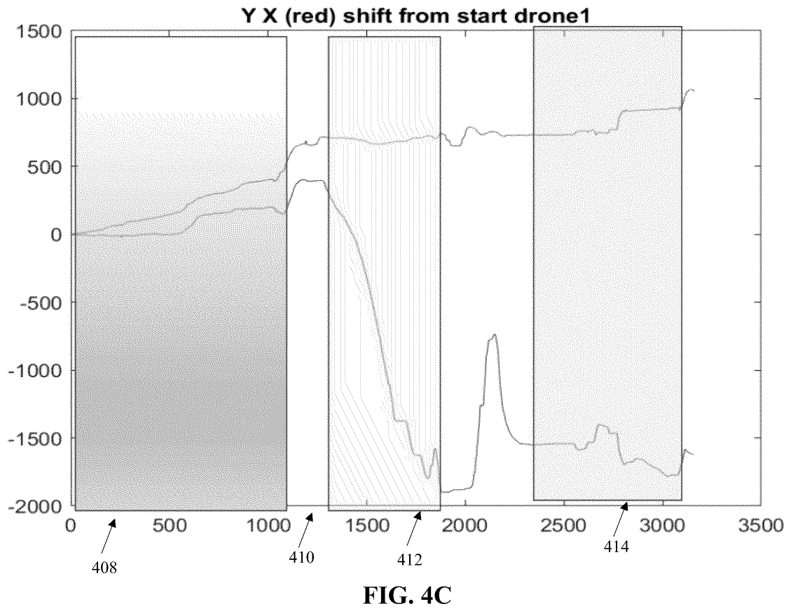

Reference is now made to FIG. 4A, which includes two images 402 and 422 captured by a camera on a drone, in accordance with some embodiments of the present invention. The drone may fly over the earth, which an environment that is substantially the same color with few features, which is difficult or not application for computing a real-time location of the drone and/or real-time mapping of an environment, such as with standard approaches of visual SLAM. At least some embodiments described herein may be used to obtain higher accuracy of computing the location (e.g., real-time) of the drone and/or mapping the environment over standard approaches.

Reference is now made to FIG. 4B, which includes two image 404 and 424 with associated pluralities of patches generated by applying segmentation on the images 402 and 422 respectively, in accordance with some embodiments of the present invention. Segmented image 404 includes multiple segmentations, each depicted as a contiguous pixel region of pixels with a same pixel intensity and/or same color. The segmentations are obtained even for images of the earth, which is substantially the same color with few features. Note that the field's pattern and irregular shape may contribute to distinctiveness, and some plants and infrastructure may be distinctive and help improve localization and mapping. Matching segmentations between sequential images are found as described herein. The location of the drone is tracked using the matching segmentations as described herein. Similarly, buildings in 424, particularly those having distinctive patterns, colors, features, and the like may contribute to localization and mapping confidence.

Reference is now made to FIG. 4C, which is a graph 406 depicting location tracking of the drone using matching segmentations of images, in accordance with some embodiments of the present invention.

FIG. 4C comprises an illustration of ‘naïve’ output of a simple tracking algorithm using the segmentation results of the original video, which may be used for capturing images such as FIG. 4A. The output may be based on matching between each two successive frames, based on ‘segments’ in the first frame with similar size, shape segments in the second frame. After filtering out fake segments, outliers, and the like the matching between each pair of segments may yield an estimate for delta X and delta Y i.e. the relative motion of that segment between the two frames in the X, Y directions. Note that this example illustrates a simple estimation, and some alternative algorithm may estimate the full 6 DOF transformation, for example by using e.g. scale changes, rotations and the like. Experiment showed the X, Y estimated motions correspond well to the actual drone camera motion in the video.

The graphs represent unit-less x, y coordinates as in the camera frame. The lower (X) and top (Y) graphs represent the estimate X, Y motion of the camera based on the relative segmentations in the subsequent frames. Hence if for example the drone camera was motionless, the two graphs would be straight horizontal lines.

For clarity of explanation, the movement of the drone is divided into portions:

Portion 408 is defined by 0-1080: drone is flying forward, with one small turn.

Portion 410 is defined by 1100-1300: drone moves left and right (turn).

Portion 412 is defined by 1320-1800: drone turns right, with long rapid turns.

Between 1800 and 2340, the drone made some rapid rotations therefore no portion is characterized for this example.

Portion 414 is defined by 2340-3100: the drone slowly moves forward.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant computer vision methods will be developed and the scopes of the terms segmentation and vSLAM are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for image matching, comprising:
receiving a plurality of images;
generating a first plurality of patches by applying segmentation on a first image from the plurality of images, and a second plurality of patches by applying segmentation on a second image from the plurality of images, each patch characterized by parameters;
selecting a group of patches from each plurality of patches, according to the parameters characterizing each patch;
generating a plurality of sets, each set comprising at least two patch from at least two different groups of patches by applying a geometric matching between the parameters characterizing each patch;
calculating a distance vector between a pivotal point of each of the patches in each of the plurality of sets; and
generating an estimate of relative camera angles and distances change by applying a statistical analysis on the distance vector pertaining to each of the plurality of sets.

2. The method of claim 1 wherein the pivotal point is the centroid of an associated patch from the plurality of patches.

3. The method of claim 1 wherein the parameters comprise a clarity score of a boundary of each patch from the first plurality of patches.

4. The method of claim 1 wherein the parameters comprise a size measure of each patch from the first plurality of patches.

5. The method of claim 1 wherein the parameters comprise a convexity score of each patch from the first plurality of patches.

6. The method of claim 1 wherein the statistical analysis comprising cross correlation of pivotal points locations.

7. The method of claim 1 wherein the plurality of images comprising at least three images and the statistical analysis comprising estimating a movement path by at least one of the plurality of sets.

8. The method of claim 1, further comprising generating at least one set based on a localized feature descriptor.

9. The method of claim 1, further comprising computing a probability the second image and the first image depict a same scene in physical space according to the parameters and updating a map pertaining to relative overlap.

10. A system comprising a storage and at least one processing circuitry configured to:
receive a plurality of images;
generate a first plurality of patches by applying segmentation on a first image from the plurality of images, and a second plurality of patches by applying segmentation on a second image from the plurality of images, each patch characterized by parameters;
select a group of patches from each plurality of patches, according to the parameters characterizing each patch;
generate a plurality of sets, each set comprising at least two patch from at least two different groups of patches by applying a geometric matching between the parameters characterizing each patch;
calculate a distance vector between a pivotal point of each of the patches in each of the plurality of sets; and
generate an estimate of relative camera angles and distances change by applying a statistical analysis on the distance vector pertaining to each of the plurality of sets.

11. The system of claim 10 wherein the pivotal point is the centroid of an associated patch from the plurality of patches.

12. The system of claim 10 wherein the parameters comprise a clarity score of a boundary of each patch from the first plurality of patches.

13. The system of claim 10 wherein the parameters comprise a size measure of each patch from the first plurality of patches.

14. The system of claim 10 wherein the parameters comprise a convexity score of each patch from the first plurality of patches.

15. The system of claim 10 wherein the statistical analysis comprising cross correlation of pivotal points locations.

16. The system of claim 10 wherein the plurality of images comprising at least three images and the statistical analysis comprising estimating a movement path by at least one of the plurality of sets.

17. The system of claim 10, wherein the at least one processing circuitry is further configured to generate at least one set based on a localized feature descriptor.

18. The system of claim 10 wherein the at least one processing circuitry is further configured to compute a probability the second image and the first image depict a same scene in physical space according to the parameters and updating a map pertaining to relative overlap.

19. One or more computer program products comprising instructions for image matching, wherein execution of the instructions by one or more processors of a computing system is to cause a computing system to:
receive a plurality of images;
generate a first plurality of patches by applying segmentation on a first image from the plurality of images, and a second plurality of patches by applying segmentation on a second image from the plurality of images, each patch characterized by parameters;
select a group of patches from each plurality of patches, according to the parameters characterizing each patch;
generate a plurality of sets, each set comprising at least two patch from at least two different groups of patches by applying a geometric matching between the parameters characterizing each patch;
calculate a distance vector between a pivotal point of each of the patches in each of the plurality of sets; and
generate an estimate of relative camera angles and distances change by applying a statistical analysis on the distance vector pertaining to each of the plurality of sets.
